(19) United States
(12) Patent Application Publication
(10) Pub. No.: US 2016/0200439 A1
(43) Pub. Date: Jul. 14, 2016

(54) AIRCRAFT AND METHOD OF SERVING PASSENGERS

(71) Applicant: SELL GMBH, Herborn (DE)

(72) Inventors: Britta APPOLT, Kuerten (DE); Mario BITTER, Olpe (DE); Markus NOVAK, Ehringshausen (DE)

(21) Appl. No.: 14/906,992

(22) PCT Filed: Oct. 6, 2014
(86) PCT No.: PCT/EP2014/002703

§ 371 Date: Jan. 22, 2016

Related U.S. Application Data
(60) Provisional application No. 61/886,078, filed on Oct. 3, 2013.

(51) Int. Cl. B64D 11/00; B64D 11/06

(52) U.S. Cl. CPC B64D 11/0007; B64D 11/06

(57) ABSTRACT

The invention relates to an aircraft (1) having a passenger cabin (8) and a plurality of passenger seats (11) arranged in this passenger cabin (8), in which the passenger seats (11) are arranged in seat rows (13) one behind the other on a cabin floor (7), and a conveyor (15) for transporting objects, meals and/or beverages to the passenger seats (11) being within and/or below the cabin floor (7).

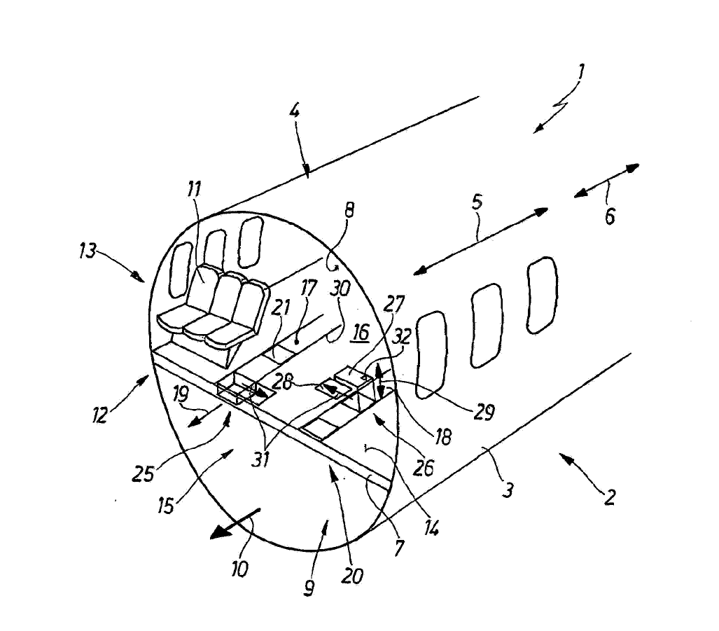

The present invention relates to an aircraft having a passenger cabin and a plurality of passenger seats in this passenger cabin, in which the passenger seats are arranged in seat rows one after the other on a cabin floor.

Furthermore, the present invention relates to a method of serving passengers in an aircraft, in which objects, meals and/or beverages are passed to the passengers at their passenger seats.

Generic aircrafts are known from the prior art and it is often customary to for example provide passengers with meals and beverages, in particular during a prolonged flight or upon request. For this purpose, food is optionally reheated in the galley of the aircraft by crew members and is centrally assembled ready for transport in service carts that are subsequently manually pushed by the crew members from seat row to seat row to pass the desired meals and beverages to the passengers. In this instance, service mostly starts in a frontmost or rearmost seat row front, or in the center, the crew members moving with the service carts seat row by seat row either forward or backward. Experience has shown that this procedure takes a relatively long time to complete until all passengers have been finally served. Furthermore, it is disadvantageous in this instance that the crew members are not, or only to a limited extent, available for other tasks during this time. Moreover, it is particularly disruptive that this service cart blocks a mostly rather narrowly built passenger aisle between the passenger seat groups during service so that neither the crew members nor the passengers can fully use the passenger aisle. This is particularly inconvenient during a visit to the lavatories because it is not rare that the service cart placed in the passenger aisle completely blocks the path for the passengers during service.

The object of the present invention is to further develop generic aircrafts in such a manner that service for the passengers is improved and that at least the previously mentioned disadvantages are overcome.

The object of the present invention is achieved by an aircraft having a passenger cabin and a plurality of passenger seats arranged in this passenger cabin, in which the passenger seats are arranged in seat rows one behind the other on a cabin floor, a conveyor for transporting objects, meals and/or beverages to the passenger seats being within and/or below the cabin floor.

Such a goods conveyor preferably integrated within the cabin floor serves to convey objects and/or particularly food in a constructive manner and using simple handling techniques directly to the passenger seats.

Thus, food and, if applicable, also objects advantageously no longer have to be mandatorily conveyed from a galley to the passenger seats in and along passenger aisles between the passenger seats or passenger seat groups so that these passenger aisles are not blocked by the service carts inevitably used so far, as a result of which passengers can make better use these passenger aisles even during service.

Thus, the actual passenger cabin and areas thereof are no longer, or at least to a lesser extent, blocked by related service operations and service devices, for example, by a service cart for transporting in particular food.

It is understood that this conveyor can transport or deliver items or goods but also remove them according to the present invention. In this instance, this preferably relates to food in general. Other objects, for example, magazines or the like can also be individually requested or delivered by the present conveyor.

The object of the present invention is also achieved by a method of serving passengers in an aircraft, in which objects, meals and/or beverages are passed to the passengers at their passenger seats, these objects, meals and/or beverages being transported within and/or below a cabin floor to the passenger seats and are made readily available at the passenger seats.

In this way, the objects and/or food can be prepared as before, for example, in the galley. Subsequently, the objects and/or food are/is however delivered to the passengers in an automated manner below the cabin floor by a conveyor and are/is provided in the area of a seat row directly at the seat. The objects and/or food provided in such a manner can then be passed by the crew members, or the passengers can help themselves without involving the crew members.

Advantageously, the crew members have more time for other tasks or services for the passengers even during the catering service.

Particularly advantageous in this instance is if the objects, meals and/or beverages are transported in a decentralized way to the passenger seats so that the bulky service carts used so far can be ideally completely omitted in the passenger aisles.

It is understood that the present conveyor may be configured in a plurality of ways.

For this purpose, the conveyor can be transversely next to and/or below the passenger seats so that the objects and/or food can be conveyed into the immediate vicinity of the passenger seats.

Cumulatively or preferably alternatively, it is possible that the conveyor is at least partially below a passenger aisle extending longitudinally of the passenger cabin between the passenger seats and/or passenger seat groups. In doing so, the space below the cabin floor can be better used for service devices or service tasks.

The previously described structural features enable a transport of objects and/or food at least below the passenger seats so that the actual space within the passenger cabin is no longer blocked by related service tasks.

Presently, it is advantageous if desired objects and/or food can be conveyed to the passenger seat or to the seat row by a correspondingly configured delivery device.

In fact, it is no less advantageous if the conveyor can also dispose of trash generated at the passenger seats.

Furthermore, it is advantageous if the conveyor comprises a delivery and/or a removal device. In order to be able to particularly convey fresh food and trash in a spatially separate manner, it is advantageous if the conveyor has a delivery device and a separate removal device.

For example, the conveyor comprises a plurality of sleds to configure the delivery and the removal device, the sleds being configured in such a manner that they can transport the objects, meals and/or beverages but also trash resulting therefrom below the cabin floor in an operationally safe manner.

It is understood that a thereto related transport of objects and/or food but also of trash may be configured by computer-assisted logistics in almost any manner.

It is particularly expedient if the delivery device and the removal device have a common transport direction. In this way, the logistic complexity at the conveyor is considerably simplified.

For example, this common transport direction runs from the galley for preparing food in the back of the passenger cabin to an additional work area for collecting trash in the front of the passenger cabin, or vice versa.

Furthermore, it is advantageous if the conveyor comprises one or a plurality of storage device(s) to intermediately store objects, meals and/or beverages.

Preferably, such a storage device is also within and/or below the cabin floor so that, for example, pre-assembled objects and/or food can be stocked within and/or below the cabin floor outside of the actual passenger cabin. In doing so, the galley or galleys can be relieved.

A preferred embodiment of the device provides that the conveyor comprises at least one transport passage that extends between a support and/or kitchen area in the passenger cabin and the seat rows. This at least one transport passage cam carry out a hermetically sealed transport.

It is understood that nearly any number of transport passages can be chosen. For example, in this instance at least two transport passages can be interactively connected to each other in such a manner that the conveyor is operable in the sense of a recirculating system.

Thus, for example, food can be delivered or provided in a first conveying direction at a first side of a longitudinal passenger aisle and in a conveying direction opposite to the first conveying direction at the other side of the longitudinal passenger aisle.

Moreover, the number of transport passages can be chosen depending on the plurality of passenger aisles between the passenger seats and/or passenger seat groups so that, for example, in so-called wide-body aircrafts having a plurality of longitudinal passenger aisles a sufficiently large number of transport possibilities, in particular transport passages, is provided.

Preferably, the at least one transport passage is configured in such a manner that a passenger cabin ambient air pressure prevails below the cabin floor so that a transfer of objects and/or food from a space below the cabin floor into the passenger cabin or vice versa is possible without difficulty.

A transfer of objects, meals and/or beverages to the passengers can be carried out simply and well if the conveyor at the seat rows comprises a supply unit for objects, meals and/or beverages transported below the cabin floor.

If this supply unit is transversely next to a passenger seat or a passenger seat group facing a passenger aisle, the objects, meals and/or beverages provided there can also be easily reached by the crew members if this is required to assist the passengers.

In regard to the supply unit, it is also understood that the supply unit can be configured in many different ways.

Expediently, the supply unit comprises a transverse transport unit having a horizontal and/or a vertical transport action that can move the delivered objects, meals and/or beverages from a transport plane of a transport passage.

While, for example, the at least one transport passage or the delivery device or the removal device ensures an axial transport of objects, meals and/or beverages in the axial direction of the longitudinal extension of the passenger cabin or of the aircraft to arrive at the individual passenger seats, a transverse transport of the objects, meals and/or beverages occurs in relation to the previously mentioned longitudinal extension by the transverse transport unit so that the objects, meals and/or beverages can be provided in a targeted manner, for example, next to a passenger seat of one of the seat rows directly facing the passenger aisle, even if the at least one transport passage or the delivery device or the removal device is below the passenger seats.

In this respect, a sled member or the like, on which the objects, meals and/or beverages are placed, can be transversely disengaged from a vertical transport plane of the transport passage or the like by the transverse conveyor.

In this instance, the sled member can be moved by the correspondingly configured horizontal transport substantially in the transverse horizontal direction while it can be moved by the correspondingly configured vertical transport in the vertical transverse direction. For example, the vertical transport comprises for this purpose a lift or lowering system and the horizontal transport comprises a sliding system.

The service for the passengers can be expedited if the conveyor comprises a plurality of mobile transport units that, loaded with objects, meals and/or beverages are movable through at least one transport passage of the conveyor. For example, such a mobile transport unit comprises a sled member that, for example, can be conveyed in a rail-mounted manner or by air pressure. In doing so, these transport units can be moved individually or in groups.

If the conveyor moreover also comprises an addressing device that can address and deliver objects, meals and/or beverages prepared in a support and/or kitchen area in an automated manner to the passenger seat so that the passenger seat group and/or the passenger seat row, the objects, meals and/or beverages can be individually provided in a safer operating manner.

The crew members or the passengers can recognize more easily when objects, meals and/or beverages are provided if the conveyor has a display that shows an imminent and or completed delivery of objects, meals and/or beverages at the supply unit.

The service for the passengers can be further improved if the conveyor comprises an ordering device for selection and ordering of objects, meals and/or beverages by a passenger at his/her seat.

Particularly preferably, the conveyor can be integrated into an aircraft if the conveyor is a supporting structural component of the cabin floor. This particularly applies to a transport passage.

The conveyor can be structurally realized in a particularly simple manner if one service opening is within the cabin floor at the seat rows located in the passenger cabin, which creates a spatial connection between the passenger cabin and the conveyor.

It is furthermore advantageous if the storage devices are connected to the passenger cabin or to the supply unit by a transport passage or preferably a plurality of transport passages so that an appropriate service can be carried out without or at least with less crew members.

Further features, effects and advantages of the present invention are explained on the basis of the appended drawing and the subsequent description, in which a section of an aircraft fuselage having a passenger cabin comprising a conveyor in a cabin floor and/or below a cabin floor for transporting objects, meals and/or beverages to the passenger seats, is illustrated and described in an exemplary manner.

The sole FIGURE of the drawing schematically shows a perspective partial view of an aircraft fuselage having a passenger cabin comprising a conveyor within and/or below the cabin floor for transporting objects, meals and/or beverages to the passenger seats.

In regard to aircraft 1 partially shown in the only FIGURE, a part 2 of an aircraft fuselage 3 is shown.

The fuselage 3 comprises a shell 4 that is divided along an axis 5 extending in a longitudinal extension 6 of the aircraft 1 by a horizontally extending cabin floor 7.

Above the cabin floor 7, a passenger cabin 8 is located that holds the passengers during a flight of the aircraft 1

Below the cabin floor 7, a technical and/or utility room 9 of the aircraft 1, which here is not further explained, is located.

The aircraft 1 moves in a direction 10 of flight during its operation.

In this respect, passenger seats 11 (only indicated schematically) aligned in the flight direction 10 are located in the cabin 8 that, for example, are organized in seat groups 12 in seat rows 13 one behind the other with reference to the axial direction 5.

These passenger seats 11 are attached to the cabin floor 7 to a top side 14 of the cabin floor 7.

Within the cabin floor 7 there is a conveyor 15 for transporting in particular meals and/or beverages so that this food or other goods can be transported within or, depending on the configuration, also below the cabin floor 7 to the seats 11 and thus can be provided in a readily available manner.

In this embodiment, the conveyor 15 is substantially transversely next to those seats 11 that are directly adjacent a passenger aisle 16 running in the longitudinal direction 6. To this extent, the conveyor 15 is for the most part directly underneath the passenger aisle 16.

In this instance, the conveyor 15 is furthermore characterized by two transport passages 17 and 18 aligned parallel to each other in which the goods and in particular the food are transported in the axial transport direction 19 or are delivered to addressed seats 11 by an addressing device here not further explained.

Each of the two transport passages 17 and 18 in itself constitutes a delivery and removal device 20, the axial main transport directions 19 of which are identical.

In this instance, the transport passages 17 and 18 form directly supporting structural components (not separately numbered) of the cabin floor 7 so that the conveyor 15 can be integrated in an overall extremely space-saving manner into the aircraft structure.

In this regard, the transport passages 17 and 18 are substantially directly underneath the passenger aisle 16.

In addition to the seats 11 facing the passenger aisle 16, one service opening 21 (only schematically illustrated) provided with a cover (not numbered) is provided in the cabin floor 7. This cover can, for example, be mounted either for pivoting about an axis or sliding in a straight line.

At these service openings 21, the conveyor 15 comprises one supply unit 25 for shifting the objects, meals and/or beverages or the like transported through the transport passages 17 and 18 at a designated seat row 13.

For this purpose, the supply units 25 each comprise one transverse transport unit 26 having at least one lift and lowering system 27 for vertical transport in the transversely vertical direction so that the mobile transport units 28 can, on the one hand, be lifted vertically by one stroke length 29 out of a transport plane 30 of the transport passages 17 and 18 and be lifted into the cabin 8, or vice versa.

On the other hand, these mobile transport units 28 can, cumulatively or alternatively, be moved in a transverse horizontal direction 31 to realize an additional horizontal transport transverse to the axial main transport directions 19.

Furthermore, the conveyor 15 comprises a display 32 that can show an imminent or completed delivery of objects, meals and/or beverages at one of the supply units 25. This display 32 is, for example, based on an optical light signal.

The conveyor 15, transports food or the like to the seats 11 in a decentralized way.

In this respect, conventional service carts or the like pushed through passenger aisle 16 can be eliminated.

It is understood that the above-described embodiment is merely a first configuration of the present invention. In this regard, the configuration of the present invention is not limited to this illustrated embodiment.

All features disclosed in the application documents are claimed as being substantial to the present invention in as far as they are novel, individually or in combination, vis-à-vis the prior art.

List of Reference Characters:

| | |
|---|---|
| 1 | Aircraft |
| 2 | Partial section |
| 3 | Aircraft fuselage |
| 4 | Shell |
| 5 | Axial direction |
| 6 | Longitudinal extension |
| 7 | Cabin floor |
| 8 | Passenger cabin |
| 9 | Technical and/or utility room |
| 10 | Flight direction |
| 11 | Passenger seats |
| 12 | Passenger seat groups |
| 13 | Seat rows |
| 14 | Top side |
| 15 | Conveyor |
| 16 | Passenger aisle |
| 17 | Right transport passage |
| 18 | Left transport passage |
| 19 | Axial main transport |
| | directions |
| 20 | Delivery and removal device |
| 21 | Service opening |
| 25 | Supply unit |
| 26 | Transverse transport unit |
| 27 | Lift and lowering system |
| 28 | Mobile transport units |
| 29 | Stroke length |
| 30 | Transport plane |
| 31 | Transverse horizontal |
| | direction |
| 32 | Display |

1. An aircraft having a passenger cabin and a plurality of passenger seats in this passenger cabin, arranged in seat rows one behind the other on a cabin floor, wherein a conveyor is provided within or below the cabin floor to transport objects, meals or beverages to the passenger seats.

2. The aircraft according to claim 1, wherein the conveyor is next to or below the passenger seats.

3. The aircraft according to claim 1, wherein the conveyor is at least partially below a passenger aisle extending in a longitudinal direction of the passenger cabin between the passenger seats or passenger seat groups.

4. The aircraft according to that claim 1, wherein the conveyor comprises a delivery device or a removal device for objects, meals or beverages.

5. The aircraft according to claim 4, wherein the delivery device or the removal device have a common transport direction.

6. The aircraft according to claim 1, wherein the conveyor comprises one or a plurality of storage devices to intermediately store objects, meals or beverages.

7. The aircraft according to claim 1, wherein the conveyor comprises at least one transport passage that extends between a support or kitchen area in the passenger cabin and the seat rows.

8. The aircraft according to claim 7, wherein the number of transport passages is chosen depending on the number of passenger aisles between the passenger seats or the passenger seat groups.

9. The aircraft according to claim 1, wherein the conveyor at the seat rows comprises a supply unit for objects, meals or beverages transported through a transport passage.

10. The aircraft according to claim 9, wherein the supply unit is next to a passenger seat or a passenger seat group that faces a passenger aisle.

11. The aircraft according to claim 9, wherein the supply unit comprises a transverse transport unit having a horizontal or a vertical transport action and can move the delivered objects, meals or beverages from a transport plane of a transport passage.

12. The aircraft according to claim 1, wherein the conveyor comprises a plurality of mobile transport units that, loaded with objects, meals or beverages, are movable through at least one transport passage of the conveyor.

13. The aircraft according to claim 1, wherein the conveyor comprises an addressing device that can address and deliver objects, meals or beverages prepared in a support or kitchen area in an automated manner to the passenger seat, a passenger seat group or a passenger seat row.

14. The aircraft according to claim 1, wherein the conveyor has a display that can show an imminent or completed delivery of objects, meals or beverages at a supply unit.

15. The aircraft according to claim 1, wherein the conveyor comprises an ordering device for selection and ordering of objects, meals or beverages by a passenger at his/her passenger seat.

16. The aircraft according to claim 1, wherein the conveyor is a supporting structural component of the cabin floor.

17. The aircraft according to claim 1, wherein the conveyor comprises respective service openings within the cabin floor at the seat rows located in the passenger cabin for creating a spatial connection between the passenger cabin and the conveyor.

18. A method of serving passengers in an aircraft in which objects, meals or beverages are passed to the passengers at their passenger seats, wherein these objects, meals or beverages are transported to the passenger seats within or below a cabin floor and are made readily available at the passenger seats.

19. The method according to claim 18, wherein the objects, meals or beverages are transported in a decentralized way to the passenger seats.
